(19) United States
(12) Patent Application Publication
(10) Pub. No.: US 2017/0058604 A1
(43) Pub. Date: Mar. 2, 2017

(54) Ladder Bracing System

(71) Applicants: Kevin D. Minette, Cocoa, FL (US); Donald Michael Zoubek, Andover, MN (US)

(72) Inventors: Kevin D. Minette, Cocoa, FL (US); Donald Michael Zoubek, Andover, MN (US)

(21) Appl. No.: 15/250,600

(22) Filed: Aug. 29, 2016

Related U.S. Application Data
(60) Provisional application No. 62/211,445, filed on Aug. 28, 2015.

(51) Int. Cl. E06C 7/48

(52) U.S. Cl. CPC E06C 7/48

(57) ABSTRACT

A ladder bracing system is used to safely lean a ladder against a building. The system includes a ladder, a first bracing arm, a second bracing arm, a bridge, a first ladder-gripping clamp and a second ladder-gripping clamp. The first bracing arm and the second bracing arm are connected to opposing ends of the bridge. The first bracing arm and the second bracing arm are used to stabilize the ladder against a building without damaging the building. The first ladder-gripping clamp is connected to the first bracing arm and the second ladder-gripping clamp is connected to the second bracing arm. The first ladder-gripping clamp and the second ladder-gripping clamp are used along with the bridge to secure the first bracing arm and the second bracing arm along the ladder. The bridge may be moved along the ladder through the use of an adjustment cable and a pulley.

The current application claims a priority to the U.S. Provisional Patent application Ser. No. 62/211,445 filed on Aug. 28, 2015.

### FIELD OF THE INVENTION

The present invention relates generally to ladder systems. More specifically, the present invention is a ladder bracing system that is fully adjustable and stabilizes a ladder without damaging the building the ladder leans against.

### BACKGROUND OF THE INVENTION

Injuries may easily occur while on a ladder due to a variety of influences. People may easily get dizzy, lose balance, or fall as a result of any movement from the ladder. Resulting injuries vary due to the surface upon which the individual falls upon, which part of the body the individual falls upon, the height of the ladder and so on. If an individual falls in a certain way, the individual may be paralyzed or may even die. A number of ladder stabilizers have attempted to solve this issue; however, none have been able to accommodate a variety of ladders while being able to securely hold a ladder.

The present invention is a fully adjustable ladder bracing system which is used to secure the ladder against a building. The ladder bracing system uses a first bracing arm and a second bracing arm which may be moved along the ladder to provide support for the ladder. The first bracing arm and the second bracing arm are designed to stabilize the ladder without damaging the building on which the ladder is leaning. When using a typical extension ladder, the ladder itself can damage the gutter of the building or scratch the wall of the building, depending on how the ladder is positioned. With the present invention, the first bracing arm and the second bracing arm may be positioned within the gutter of a building or rest against the fascia of the building in order to provide adequate support.

### BRIEF DESCRIPTION OF THE DRAWINGS

FIG. 1 is a left perspective view of the present invention.

FIG. 2 is a right perspective view of the present invention.

FIG. 3 is an exploded left perspective view of the present invention, showing the arrangements of a first ladder-gripping clamp, a second ladder-gripping clamp, a first bracing foot, and a second bracing foot.

FIG. 4 is an exploded left perspective view of the present invention showing the arrangements of a first pair of low friction clips, a second pair of low friction clips, a third pair of low friction clips and a fourth pair of low friction clips.

FIG. 5 is a front view of the present invention.

FIG. 6 is a left perspective view of the present invention with a ladder.

FIG. 7 is a back right perspective view of the present invention with the ladder.

FIG. 8 is a left perspective view of the present invention with the first bracing arm and the second bracing arm mounted in a flipped orientation with respect to the ladder.

### DETAILED DESCRIPTION OF THE INVENTION

All illustrations of the drawings are for the purpose of describing selected versions of the present invention and are not intended to limit the scope of the present invention.

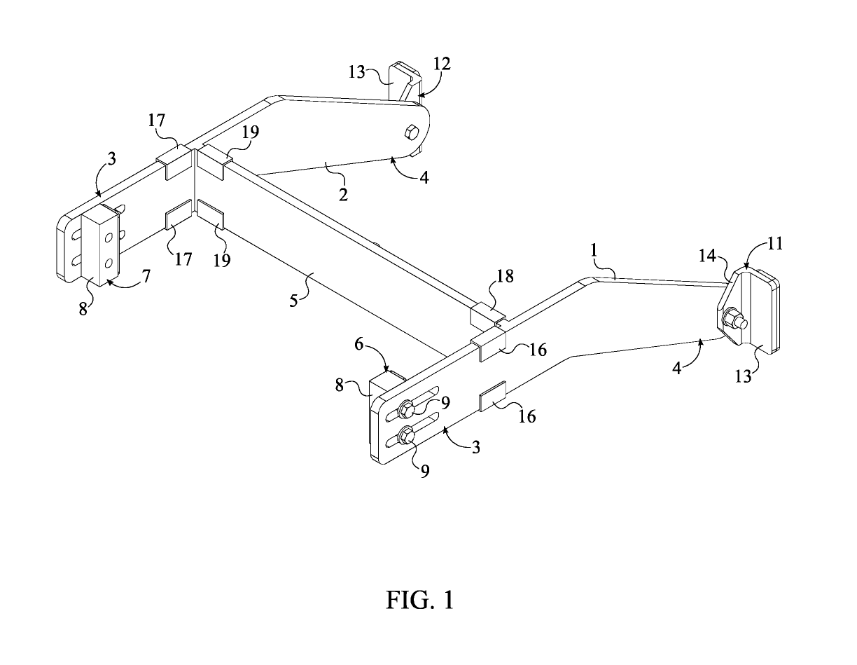

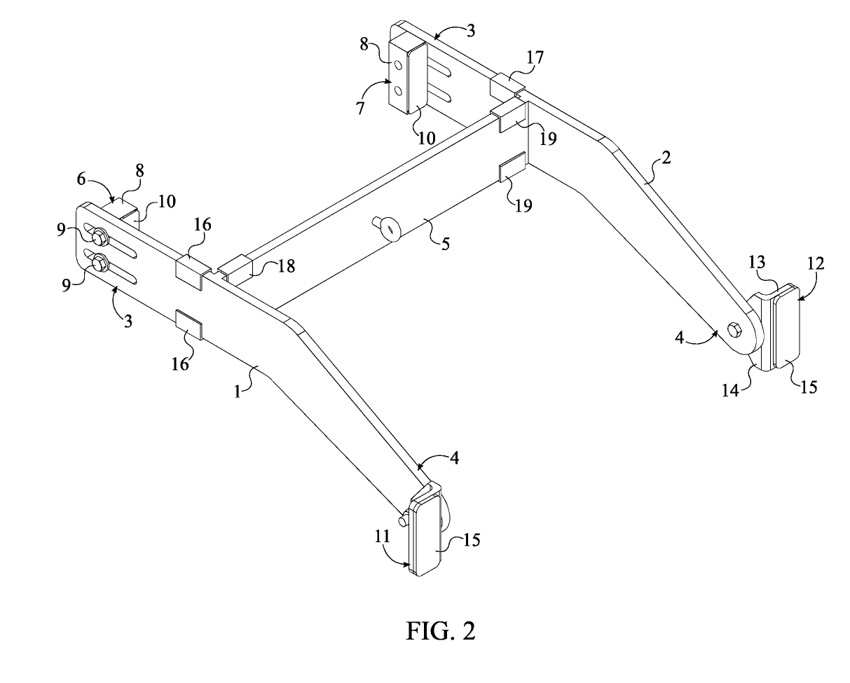

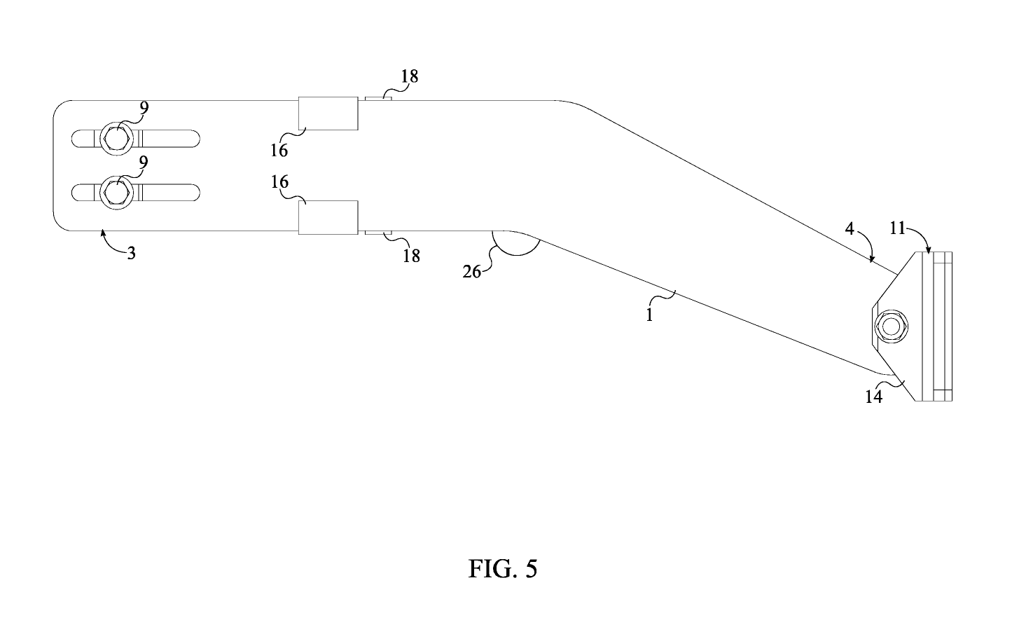

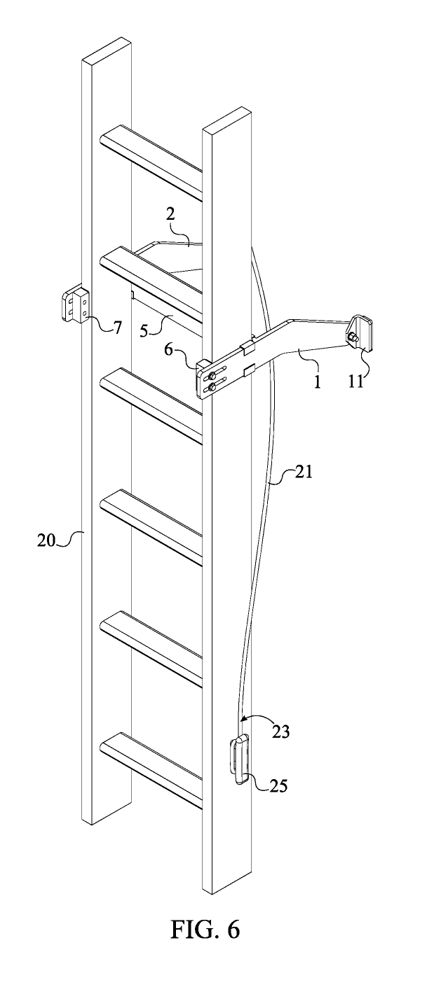

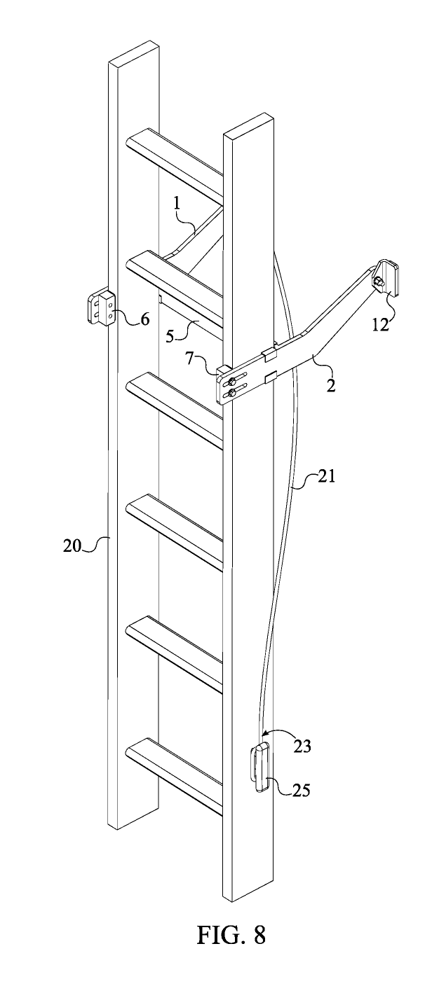

With reference to FIGS. 1-2, the present invention is a ladder bracing system used for securing a ladder against a building. The present invention is designed to rest against the fascia or within the gutter of a building without damaging the building. The present invention comprises a first bracing arm 1, a second bracing arm 2, a bridge 5, a first ladder-gripping clamp 6, and a second ladder-gripping clamp 7. The first bracing arm 1 and the second bracing arm 2 protrude from a ladder in order to safely brace the ladder against a building. The first bracing arm 1 and the second bracing arm 2 each comprise a rail portion 3 and a free portion 4. The rail portion 3 is positioned adjacent to the free portion 4. Together, the rail portion 3 of the first bracing arm 1 and the rail portion 3 of the second bracing arm 2 fit around the rails of the ladder. The free portion 4 is used to brace the ladder against the building. The rail portion 3 of the first bracing arm 1 is connected adjacent the bridge 5. The rail portion 3 of the second bracing arm 2 is connected adjacent to the bridge 5, opposite to the first bracing arm 1. This arrangement allows for the first bracing arm 1 and the second bracing arm 2 to be positioned on either side of the ladder. The first bracing arm 1 and the second bracing arm 2 are positioned parallel to each other. This is done to support the ladder uniformly against a building. In the preferred embodiment of the present invention, the rail portion 3 and the free portion 4 are oriented at an obtuse angle 26 to each other. This is shown in FIG. 5. This arrangement allows the first bracing arm 1 and the second bracing arm 2 to be mounted in differing orientations, shown in FIG. 6 and FIG. 8. By flipping the first bracing arm 1 and the second bracing arm 2, the free portions 4 of both the first bracing arm 1 and the second bracing arm 2 may be rested into a gutter or against the fascia of a building.

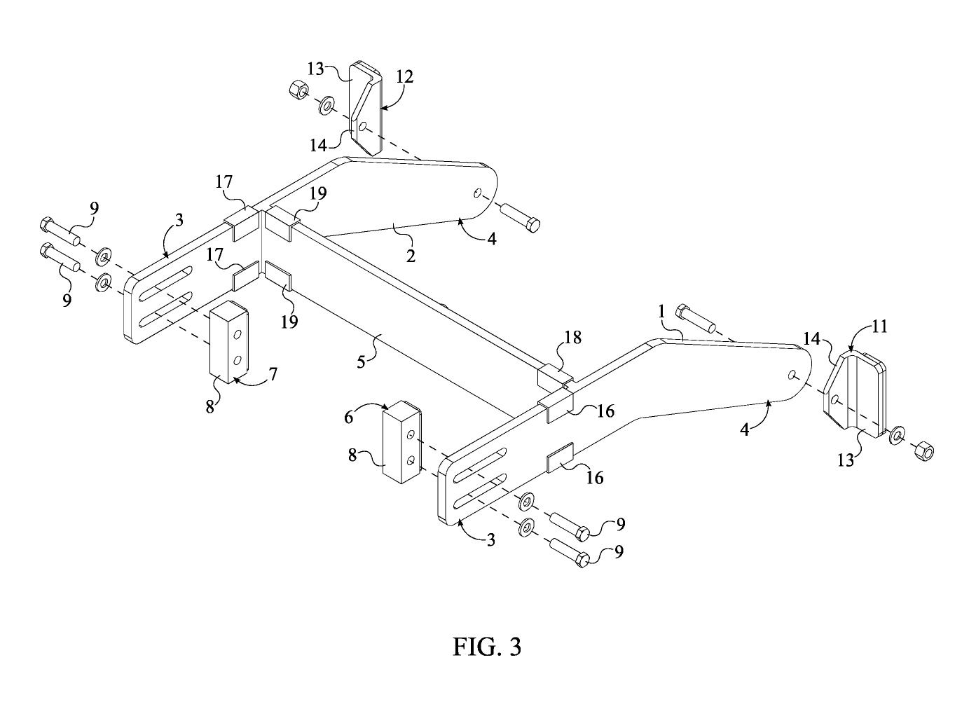

In reference to FIGS. 2-3, the first ladder-gripping clamp 6 is mounted onto the rail portion 3 of the first bracing arm 1. Similarly, the second ladder-gripping clamp 7 is mounted onto the rail portion 3 of the second bracing arm 2. Together, the first ladder-gripping clamp 6 and the second ladder-gripping clamp 7 are used to secure the first bracing arm 1 and the second bracing arm 2 to a ladder. The first ladder-gripping clamp 6 and the second ladder-gripping clamp 7 are oriented towards each other. With this arrangement, the ladder can be pressed in between the bridge 5 and both the first ladder-gripping clamp 6 and the second ladder-gripping clamp 7. Further, in this arrangement the first bracing arm 1 and the second bracing arm 2 are permitted to slide along the ladder without falling off the ladder.

In reference to FIGS. 2-3, the present invention further comprises a first bracing foot 11 and a second bracing foot 12. The first bracing foot 11 is mounted adjacent to the free portion 4 of the first bracing arm 1, opposite to the rail portion 3 of the first bracing arm 1. Similarly, the second bracing foot 12 is mounted adjacent to the free portion 4 of the second bracing arm 2, opposite to the rail portion 3 of the second bracing arm 2. The first bracing foot 11 and the second bracing foot 12 are used to stabilize the first bracing arm 1 and the second bracing arm 2 against a building. The first bracing foot 11 and the second bracing foot 12 are designed to prevent the present invention from damaging the building.

In reference to FIGS. 2-3, the first bracing foot 11 and the second bracing foot 12 each comprise a base panel 13, a flange tab 14, and a base grip 15. When in use, the base panel 13 rests against the building. The flange tab 14 is connected adjacent and perpendicular to the base portion. The flange tab 14 of the first bracing foot 11 is used to connect the first bracing foot 11 to the first bracing arm 1. Similarly, the flange tab 14 of the second bracing foot 12 is used to connect the second bracing foot 12 to the second bracing arm 2. The base grip 15 is connected across the base portion, opposite to the flange portion and is used to prevent the base panel 13 from slipping along the building. In the preferred embodiment of the present invention, the first bracing foot 11 is rotatably mounted to the first bracing arm 1 and the second bracing foot 12 is rotatably mounted to the second bracing arm 2. This arrangement allows the first bracing foot 11 and the second bracing foot 12 to be adjusted based on the angle in which the ladder leans against the building.

In reference to FIGS. 2-3, the first ladder-gripping clamp 6 and the second ladder-gripping clamp 7 each comprise an adjustable block 8 and at least one adjusting peg 9.

Together, the adjustable block 8 and the at least one adjustable peg are used to secure the first bracing arm 1 and the second bracing arm 2 to the ladder. The adjustable block 8 is attached to the at least one adjusting peg 9. The at least one adjusting peg 9 of the first ladder-gripping clamp 6 is slidably engaged with the rail portion 3 of the first bracing arm 1. Similarly, the at least one adjusting peg 9 of the second ladder-gripping clamp 7 is slidably engaged with the rail portion 3 of the second bracing arm 2. This arrangement allows the adjustable block 8 of the first ladder-gripping clamp 6 and the adjustable block 8 of the second ladder-gripping clamp 7 to slide relative to the bridge 5 and grasp the ladder.

In reference to FIG. 2, the first ladder-gripping clamp 6 and the second ladder-gripping clamp 7 each further comprise a low friction pad 10. The low friction pad 10 is connected adjacent to the adjustable block 8 and is oriented towards the bridge 5. The low friction pad 10 allows the adjustable block 8 to slide relative to the ladder such that the present invention may be moved along the ladder as needed.

In reference to FIG. 1, when using the present invention, the adjusting peg 9 of the first ladder-gripping clamp 6 and the adjusting peg 9 of the second ladder-gripping peg may be moved away from the bridge 5 in order to allow the present invention to slide readily along the ladder. Alternatively, the at least one adjusting peg 9 of the first ladder-gripping clamp 6 may be fixed at a first desired position along the rail portion 3 of the first bracing arm 1. Similarly, the at least one adjusting peg 9 of the second ladder-gripping clamp 7 may be fixed at a second desired position along the rail portion 3 of the second bracing arm 2. By fixing the adjusting peg 9 of the first ladder-gripping clamp 6 and the adjusting peg 9 of the second ladder-gripping clamp 7, the present invention may be firmly secured at any position along the ladder.

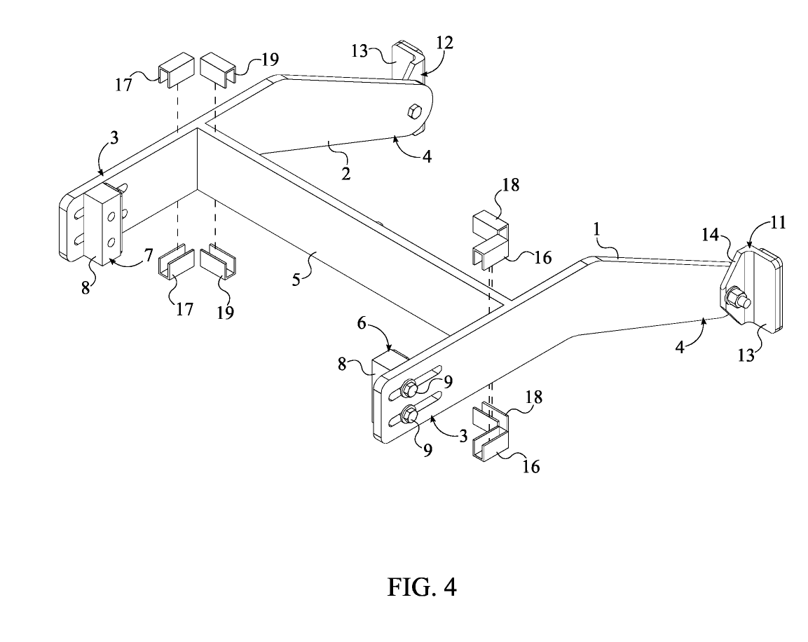

In reference to FIG. 4, the present invention further comprises a first pair of low friction clips 16. The first pair of low friction clips 16 is used to aid the first bracing arm 1 in sliding along the ladder. The first pair of low friction clips 16 is laterally attached to the rail portion 3 of the first bracing arm 1. When the present invention is mounted onto the ladder, the first pair of low friction clips 16 fits in-between the ladder and the first bracing arm 1 to permit movement between the first bracing arm 1 and the ladder. The first pair of low friction clips 16 is positioned adjacent to the bridge 5, opposite to the free portion 4 of the first bracing arm 1. The first pair of low friction clips 16 is positioned opposite to each other across the rail portion 3 of the first bracing arm 1. This arrangement allows the first bracing arm 1 to slide evenly along the ladder.

Similar to the first pair of low friction clips 16, the present invention further comprises a second pair of low friction clips 17. In reference to FIG. 4, the second pair of low friction clips 17 is used to aid the second bracing arm 2 in sliding along the ladder. The second pair of low friction clips 17 is laterally attached to the rail portion 3 of the second bracing arm 2. When the present invention is mounted onto the ladder, the second pair of low friction clips 17 fits in-between the ladder and the second bracing arm 2 to permit movement between the second bracing arm 2 and the ladder. The second pair of low friction clips 17 is positioned adjacent to the bridge 5, opposite to the free portion 4 of the second bracing arm 2. The second pair of low friction clips 17 is positioned opposite to each other across the rail portion 3 of the second bracing arm 2. This arrangement allows the second bracing arm 2 to slide evenly along the ladder.

In reference to FIG. 4, the present invention further comprises a third pair of low friction clips 18 and a fourth pair of low friction clips 19. The third pair of low friction clips 18 and the fourth pair of low friction clips 19 are used to aid the bridge 5 in sliding along the ladder. The third pair of low friction clips 18 is laterally attached to the bridge 5 and is positioned adjacent to the first bracing arm 1. The fourth pair of low friction clips 19 is laterally attached to the bridge 5 and is positioned adjacent to the second bracing arm 2. This arrangement distributes the third pair of low friction clips 18 and the fourth pair of low friction clips 19 evenly along the bridge 5. The third pair of low friction clips 18 is positioned opposite to each other across the bridge 5. Similarly, the fourth pair of low friction clips 19 is positioned opposite to each other across the bridge 5. This allows the bridge 5 to slide evenly along the ladder.

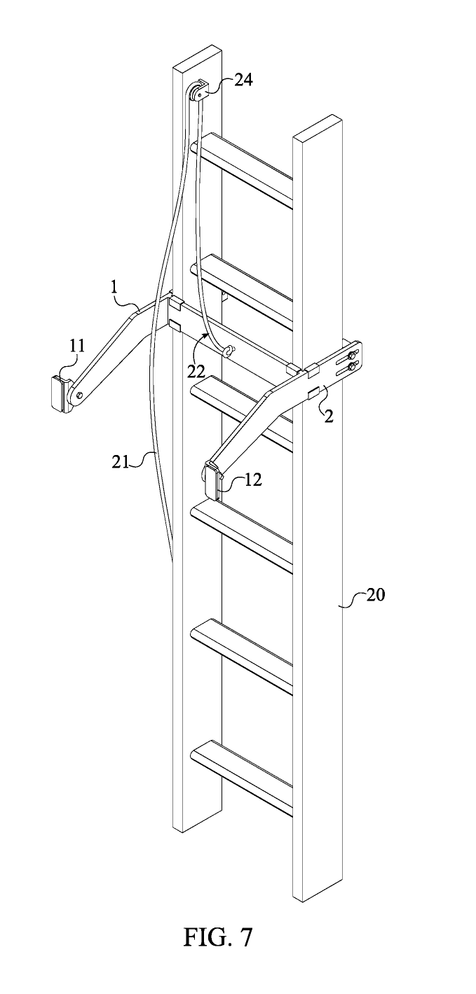

In reference to FIGS. 6-8, the present invention further comprises a ladder 20, an adjustment cable 21, a pulley 24, and a cleat 25. The adjustment cable 21 is used to move the bridge 5 along the ladder 20. A first end 22 of the adjustment cable 21 is fixed to the bridge 5. In the preferred embodiment of the present invention, the first end 22 of the adjustment cable 21 is fixed to the bridge 5 through the use of an eyebolt. The pulley 24 is connected along the ladder 20 and is used to redirect the adjustment cable 21. The adjustment cable 21 is tensionably engaged to the pulley 24 such that if the ladder 20 is standing up, pulling on the adjustment cable 21 will move the bridge 5 along the ladder 20 towards the pulley 24. The cleat 25 is connected along the ladder 20 and is offset from the pulley 24. The cleat 25 is used to secure the adjustment cable 21. To do so, a second end 23 of the adjustment cable 21 is fixed to the cleat 25. By securing the adjustment cable 21, the bridge 5 is prevented from moving along the ladder 20.

Although the invention has been explained in relation to its preferred embodiment, it is to be understood that many other possible modifications and variations can be made without departing from the spirit and scope of the invention as hereinafter claimed.

What is claimed is:

1. A ladder bracing system comprises:
a first bracing arm;
a second bracing arm;
a bridge;
a first ladder-gripping clamp;
a second ladder-gripping clamp;
the first bracing arm and the second bracing arm each comprise a rail portion and a free portion;
the rail portion being positioned adjacent to the free portion;
the rail portion of the first bracing arm being connected adjacent to the bridge;
the rail portion of the second bracing arm being connected adjacent to the bridge, opposite to the first bracing arm;
the first bracing arm and the second bracing arm being oriented parallel to each other;
the first ladder-gripping clamp being mounted onto the rail portion of the first bracing arm;
the second ladder-gripping clamp being mounted onto the rail portion of the second bracing arm; and
the first ladder-gripping clamp and the second ladder-gripping clamp being oriented towards each other.

2. The ladder brace as claimed in claim 1 comprises:
a first bracing foot;
a second bracing foot;
the first bracing foot being mounted adjacent to the free portion of the first bracing arm, opposite to the rail portion of the first bracing arm; and
the second bracing foot being mounted adjacent to the free portion of the second bracing arm, opposite to the rail portion of the second bracing arm.

3. The ladder bracing system as claimed in claim 2 comprises:
the first bracing foot and the second bracing foot each comprise a base panel, a flange tab, and a base grip;
the flange tab being connected adjacent and perpendicular to the base portion; and
the base grip being connected across the base portion, opposite to the flange portion.

4. The ladder bracing system as claimed in claim 2 comprises:
the first bracing foot being rotatably mounted to first bracing arm; and
the second bracing foot being rotatably mounted to first bracing arm.

5. The ladder bracing system as claimed in claim 1 comprises:
the first ladder-gripping clamp and the second ladder-gripping clamp each comprise an adjustable block and at least one adjusting peg;
the adjustable block being attached to the at least one adjusting peg;
the at least one adjusting peg of the first ladder-gripping clamp being slidably engaged with the rail portion of the first bracing arm; and
the at least one adjusting peg of the second ladder-gripping clamp being slidably engaged with the rail portion of the second bracing arm.

6. The ladder bracing system as claimed in claim 5 comprises:
the first ladder-gripping clamp and the second ladder-gripping clamp each further comprise a low friction pad;
the low friction pad being connected adjacent to the adjustable block; and
the low friction pad being oriented towards the bridge.

7. The ladder bracing system as claimed in claim 5 comprises:
the at least one adjusting peg of the first ladder-gripping clamp being fixed at a first desired position along the rail portion of the first bracing arm; and
the at least one adjusting peg of the second ladder-gripping clamp being fixed at a second desired position along the rail portion of the second bracing arm.

8. The ladder bracing system as claimed in claim 1 comprises:
a first pair of low friction clips;
the first pair of low friction clips being laterally attached to the rail portion of the first bracing arm;
the first pair of low friction clips being positioned adjacent to the bridge, opposite to the free portion of the first bracing arm; and
the first pair of low friction clips being positioned opposite to each other across the rail portion of the first bracing arm.

9. The ladder bracing system as claimed in claim 1 comprises:
a second pair of low friction clips;
the second pair of low friction clips being laterally attached to the rail portion of the second bracing arm;
the second pair of low friction clips being positioned adjacent to the bridge, opposite to the free portion of the second bracing arm; and
the second pair of low friction clips being positioned opposite to each other across the rail portion of the second bracing arm.

10. The ladder bracing system as claimed in claim 1 comprises:
a third pair of low friction clips;
the third pair of low friction clips being laterally attached to the bridge;
the third pair of low friction clips being positioned adjacent to the first bracing arm; and
the third pair of low friction clips being positioned opposite to each other across the bridge.

11. The ladder bracing system as claimed in claim 1 comprises:
a fourth pair of low friction clips;
the fourth pair of low friction clips being laterally attached to the bridge;
the fourth pair of low friction clips being positioned adjacent to the second bracing arm; and
the fourth pair of low friction clips being positioned opposite to each other across the bridge.

12. The ladder bracing system as claimed in claim 1 comprises:
a ladder
an adjustment cable;
a pulley;
a cleat;
a first end of the adjustment cable being fixed to the bridge;
the pulley being connected along the ladder;
the cleat being connected along the ladder, offset from the pulley;
the adjustment cable being tensionably engaged to the pulley; and
a second end of the adjustment cable being fixed to the cleat.

13. The ladder bracing system as claimed in claim 1 comprises:
the rail portion and the free portion being oriented at an obtuse angle to each other.
